(19) United States
(12) Patent Application Publication
(10) Pub. No.: US 2015/0056003 A1
(43) Pub. Date: Feb. 26, 2015

(54) TUBULAR FRAME STRUCTURE AND RELATED METHOD OF CONSTRUCTION

(71) Applicants: Thomas N. Ludwig, JR., Sidney, OH (US); Robert L. Finney, JR., Kettering, OH (US); Gregory A. Balnoschan, Katy, TX (US)

(72) Inventors: Thomas N. Ludwig, JR., Sidney, OH (US); Robert L. Finney, JR., Kettering, OH (US); Gregory A. Balnoschan, Katy, TX (US)

(21) Appl. No.: 13/971,479

(22) Filed: Aug. 20, 2013

(51) Int. Cl. F16B 7/22; B23P 19/00

(52) U.S. Cl. CPC F16B 7/22; B23P 19/00
USPC 403/263; 29/428; 29/525.14

(57) ABSTRACT

A method of constructing a metal tubular frame structure utilizing a first tubular member and a second tubular member is provided. The method involves utilizing at least one opening in the first tubular member and at least one end tab on the second tubular member that together produce a keyed tubular joint when the second tubular member engages the first tubular member with the tab inserted within the opening. Keyed tubular insert-type joints, keyed tubular miter-type joints and keyed tubular flush-type joints can be formed.

### TECHNICAL FIELD

This application relates generally to tubular frame structures for use in bakery processing equipment and, more specifically, to a method of constructing a tubular frame structure that utilizes self-fixturing of interconnecting tubular components.

### BACKGROUND

Commercial dough handling apparatus such as horizontal dough mixers, rotary dough feeders, spiral dough feeders, dough conveyors and dough dividers commonly use frame structures. Construction of such frame structures can be time-consuming and expensive.

It would be desirable to provide a frame system and method that facilitates the construction process as well as an effective frame configuration, providing stable, strong welded joints between interconnected tubular members.

### SUMMARY

In one aspect, a method of constructing a metal tubular frame structure utilizing a first tubular member and a second tubular member is provided. The method involves utilizing at least one opening in the first tubular member and at least one end tab on the second tubular member that together produce a keyed tubular joint when the second tubular member engages the first tubular member with the tab inserted within the opening.

In another aspect, a method of constructing a metal tubular frame structure utilizing a first tubular member and a second tubular member is provided, where a transverse cross-sectional size of the first tubular member is larger than a transverse cross-sectional size of the second tubular member. The method involves utilizing a set of openings in the first tubular member and a set of end tabs in the second tubular member that together produce a keyed tubular insert joint when the second tubular member is inserted into the first tubular member.

In one implementation of the foregoing aspect, the method includes: the first tubular member including a first opening in a sidewall of the first tubular member, the first opening shaped and sized to substantially match an outer perimeter shape of a sidewall of the second tubular member; the first tubular member including at least second and third openings in the sidewall of the first tubular member in respective positions that are spaced from the first opening, but that are aligned along a length of the first tubular member with the first opening; the second tubular member including at least first and second sidewall extension tabs in a first end of the second tubular member, the first and second sidewall extension tabs sized and shaped to substantially match the size and shape of the second and third openings; inserting the first end of the second tubular member into the first opening of the first tubular member; aligning the first sidewall extension tab of the second tubular member with the second opening of the first tubular member, and aligning the second sidewall extension tab of the second tubular member with the third opening of the second tubular member; moving the first end of the second tubular member further into the first opening of the first tubular member so that the first sidewall extension tab moves into the second opening and the second sidewall extension tab moves into the third opening, such that rotation of the second tubular member relative to the first tubular member is substantially inhibited by interaction of the first sidewall extension tab and the second opening and the second sidewall extension tab and the third opening.

In one implementation of the method of the preceding paragraph, the method further involves: welding the first sidewall extension tab of the second tubular member to the sidewall of the first tubular member; (ii) welding the second sidewall extension tab of the second tubular member to the sidewall of the first tubular member; and (iii) welding the sidewall of the second tubular member to the sidewall of the first tubular member along a perimeter of the first opening.

In a further aspect, a metal tubular frame structure includes a first tubular member and a second tubular member. The first tubular member and second tubular member are joined together, with at least one opening of the first tubular member and at least one end tab of the second tubular member engaged to define a keyed tubular joint.

In another aspect, a metal tubular frame structure includes a first tubular member and a second tubular member, where a transverse cross-sectional size of the first tubular member is larger than a transverse cross-sectional size of the second tubular member. The first tubular member and second tubular member are joined together, with a set of openings of the first tubular member and a set of end tabs of the second tubular member engaged to define a keyed tubular insert joint.

In one implementation of the foregoing aspect, the first tubular member has a first sidewall opening shaped and sized to substantially match an outer perimeter shape of a sidewall of the second tubular member, and second and third sidewall openings in respective positions that are spaced from the first opening but aligned with the first opening along a length of the first tubular member. The second tubular member has a first end with first and second sidewall extension tabs formed therein, where the first and second sidewall extension tabs are sized and shaped to substantially match the size and shape of the second and third openings respectively. The first end of the second tubular member is located within the first opening of the first tubular member, with the first sidewall extension tab located within the second opening and the second sidewall extension tab located within the third opening.

In one implementation of the structure of the preceding paragraph, the joint is made permanent. In particular, the first sidewall extension tab is welded to the sidewall of the first tubular member to cover an exterior side of the second opening with weld material. The second sidewall extension tab is welded to the sidewall of the first tubular member to cover an exterior side of the third opening with weld material. The sidewall of the second tubular member is welded to the sidewall of the first tubular member to form a fillet weld along a perimeter of the first opening.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a perspective view of an exemplary tubular frame structure;

FIG. 2 is a perspective view of one end of a tubular member;

FIG. 3 is a top plan view of the end of the tubular member of FIG. 2 joined to another tubular member;

FIG. 4 is a partial side elevation of the other tubular of FIG. 3 showing openings in the sidewall of such tubular member;

FIG. 5 is a partial cross-section showing a joint embodiment in which sidewall extension tabs do not protrude;

FIG. 6 is a side elevation of the end of a tubular member in an embodiment in which the end edges of the sidewall extension tabs are contoured in the lengthwise direction of the tubular member;

FIG. 7 is a partial cross-section of one embodiment of a finished sidewall extension tab weld;

FIG. 8 is a partial cross-section of another embodiment of a finished sidewall extension tab weld;

FIGS. 9, 10, 10A and 11 illustrate embodiments with three, four, four and one sidewall extension tab openings, respectively; and

FIGS. 12 and 13 show both a keyed miter-type tubular joint and a keyed flush-type tubular joint.

### DETAILED DESCRIPTION

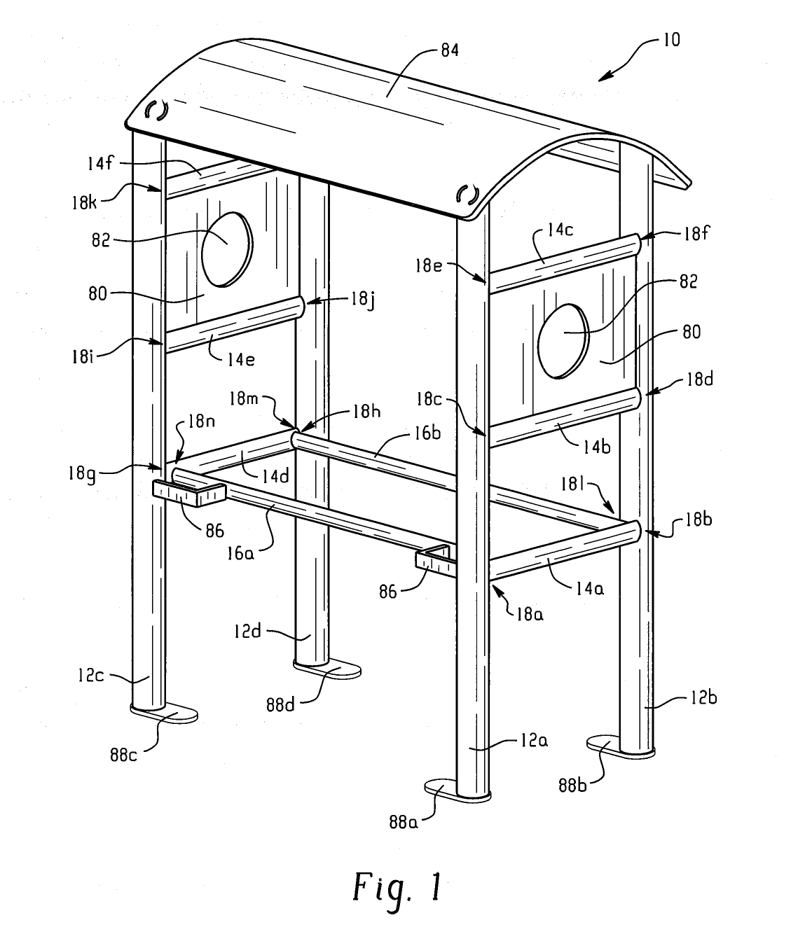

Referring to FIG. 1, an exemplary dough mixer frame structure 10 is shown and is made up of a plurality of tubular members, including upright tubular members 12a-12d, lateral tubular members 14a-14f and lateral tubular members 16a-16b. Lateral tubular members 14a-14c extend between upright tubular members 12a and 12b. Lateral tubular members 14d-14f extend between upright tubular members 12c and 12d. Lateral tubular members 16a and 16b extend between lateral tubular members 14a and 14d. A keyed tubular joint is formed at each of the multiple tubular joint locations (e.g., 18a-18n). In this case each keyed tubular joint is a keyed tubular insert joint in which one tubular member is smaller than another and has an end inserted within a sidewall opening of the larger tubular member as will be described further below, but it is contemplated that one or more of the joints could also be non-insertion type joints in which there is no opening that is large enough to receive the entire end of the mated tube as will also be described further below. Accordingly, it is recognized that the illustrated tubular frame configuration is one example only, and that the overall tubular frame configuration (e.g., number of interconnected tubular members, size of the members, configuration of the members and resulting frame structure etc.) could vary without departing from the scope or nature of the invention, which resides primarily in the configuration of each of the multiple keyed tubular insert joints and the method of manufacturing a frame structure using one or more of such joints.

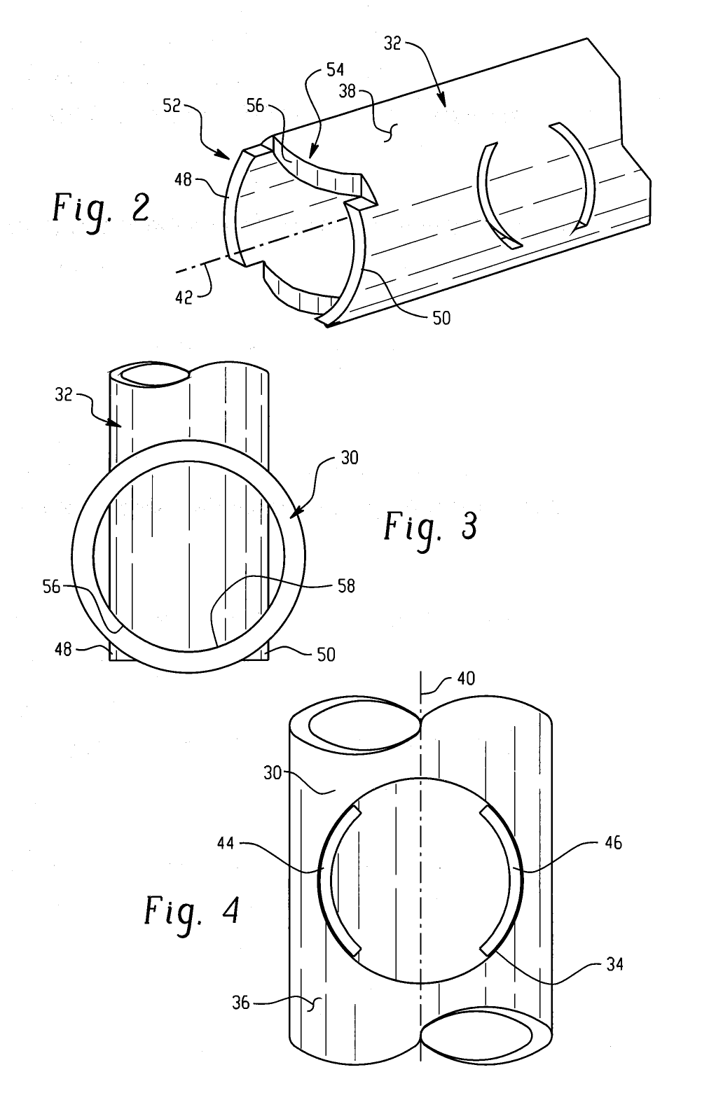

Referring now to FIGS. 2-4, one embodiment of such a keyed tubular insert joint is described with reference to exemplary tubular members 30 and 32, where a transverse cross-sectional size of the tubular member 30 is larger than a transverse cross-sectional size of the tubular member 32. In the case of the illustrated right circular cylinder type tubular members, the transverse cross-sectional size of each tubular member is defined by the area encompassed within a circle defined by the outer surface of tubular member in a plane that is perpendicular to a longitudinal axis of the tubular member. It is, however, recognized that other tubular member shapes could be used (e.g., square or other rectangular, oval etc.). The lengthwise axis 40 and 42 of each member 30 and 32 is shown in FIGS. 4 and 2.

In order to produce the keyed tubular insert joint, an opening 34 is created (e.g., cut or otherwise formed) in the sidewall 36 of the larger tubular member 30, where the opening 34 is shaped and sized to substantially match an outer perimeter shape of the sidewall 38 of the tubular member 30, while at the same time being large enough to enable insertion of tubular member 32 within the opening 34 as will be described further below. Additional openings 44 and 46 are also created in the sidewall 36 of the larger tubular member 30. As shown in FIG. 4, the openings 44 and 46 are located in respective positions that are circumferentially spaced from the opening 34, but aligned along a length of the tubular member with the opening 34. In FIG. 4, which is a side elevation of part of tubular member 30, the openings 44 and 46 are visible through the opening 34 because they are located on the side of the tubular member directly opposite the side in which opening 34 is located.

Sidewall extension tabs 48 and 50 are created at the end 52 of the tubular member 32, where sidewall extension tabs 48 and 50 are sized and shaped to substantially match the size and shape of the openings 44 and 46 respectively, while at the same time being small enough to enable insertion of extension tabs 48 and 50 within the openings 44 and 46 as will be described further below.

To assemble the keyed tubular insert joint, the end 52 of the tubular member 32 is inserted into the opening 34 of the tubular member 30. The sidewall extension tabs 48 and 50 of the tubular member 32 are aligned with the openings 44 and 46 of the tubular member 30 (e.g., by rotation of the tubular member 32 as necessary). The end 52 of the tubular member 32 is moved further into the opening 34 of the tubular member 30 so that the sidewall extension tab 48 moves into one of the openings 44, 46 and the sidewall extension tab 50 moves into the other of the openings 44, 46. When in this position, rotation of the tubular member 32 relative to the tubular member 30 is substantially inhibited by interaction of the sidewall extension tabs 48 and 50 and the openings 44 and 46. Thus, the sidewall extension tabs 48 and 50 and openings 44 and 46 combine to form a keyed relationship between the end 52 of the tubular member 32 and the sidewall 38 of the tubular member 30. As used herein, the term “keyed” relationship or “keyed” joint is meant to define a configuration in which the sidewall extension tabs of one tubular member (e.g., member 32) can only be inserted into the corresponding openings of the other tubular member (e.g., member 30) when the one tubular member has an appropriate rotational position (i.e., one specific rotational position, or in some cases one of several specific rotational positions) relative to the other tubular member so that the sidewall extension tabs align with the openings. This keyed relationship helps properly orient and locate the two tubular members relative to each other in a self-fixturing manner that facilitates the welding of the two tubular members together. Where the tubular members include additional sets of openings and/or extension tabs to make further connections to other tubular members, the self-fixturing also properly locates such additional openings and/or extension tabs.

During the welding process, the sidewall extension tab 48 of the tubular member 32 is welded to the sidewall 36 of the tubular member 30 (e.g., at the perimeter of one of the openings 44, 46), the sidewall extension tab 50 of the tubular member 32 is welded to the sidewall 36 of the tubular member 30 (e.g., at the perimeter of the other of the openings 44, 46) and the sidewall 38 of the tubular member 32 is welded to the sidewall 36 of the tubular member 30 (e.g., along the outer surface of tubular member 32 at the perimeter of the opening 34).

The sidewall extension tabs 48 and 50 are formed such that an end slot 54 formed in the sidewall 38 of the tubular member 32 in a region between the sidewall extension tabs defines a sidewall end edge portions 56 that is configured to match a shape of an internal surface 58 of the sidewall 36 of the tubular member 30 in a region between the openings 44 and 46. The sidewall end edge portion 56 is moved into contact with the internal surface 58 as best seen in FIG. 3, and the abutment acts to limit the extent of the movement of tubular member 32 into the tubular member 30. Two slots 54 and two end edge portions 56 are provided in the illustrated embodiment of FIG. 3, but the number could vary.

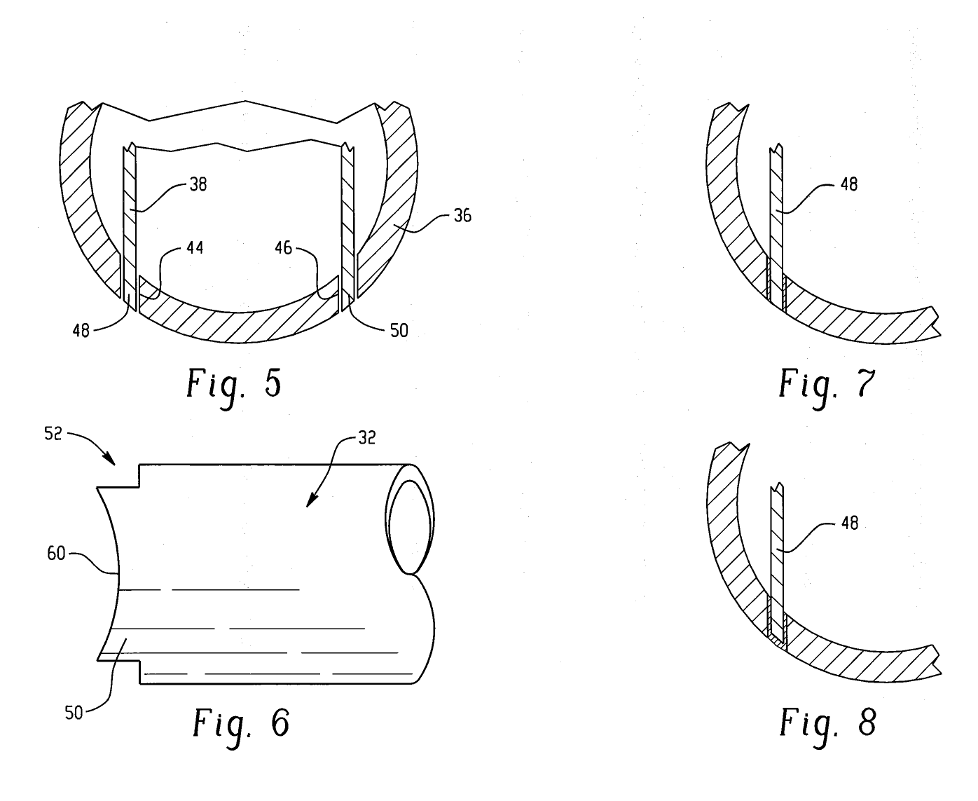

As seen in FIG. 3, in one embodiment the sidewall extension tabs 48 and 50 are sized lengthwise so as to extend fully through and protrude from the openings 44 and 46. However, in another embodiment the sidewall extension tabs are sized to move into, but not entirely through, the openings 44 and 46 (e.g., per the schematic cross-section of FIG. 5). In furtherance of achieving this latter arrangement, when necessary, the end edge of each of the sidewall extension tabs 48 and 50 should be contoured in a lengthwise direction of the tubular member 32 to match varying position of the sidewall 36 of the tubular member 30 in each of the openings 44 and 46 respectively. One example of such lengthwise contouring of an end edge 60 of sidewall extension tab 50 is shown in the side elevation view of FIG. 6.

In one implementation, the welding step for each of the sidewall extension tabs 48 and 50 completely fills an exterior side of both the openings 44 and 46 with weld material (e.g., either around the extension tabs 48 and 50 in the protruding embodiment of FIG. 3, or both around the extension tabs and over the end edges of the extension tabs in the non-protruding embodiment of FIG. 5). The weld material (or weld material and sidewall extension tabs) can then be machined and/or polished to produce a smooth external surface, flush with an exterior surface of the sidewall 36 of the tubular member 30 per the embodiments reflected in FIGS. 7 and 8. A fillet weld may be produced between the sidewall 38 of the tubular member 32 and the sidewall 36 of the tubular member 30 along the perimeter of the opening 34 of the tubular member 30.

By the above process, a tubular frame structure (e.g., 10 of FIG. 1) of a dough handling apparatus can be produced, where a plurality of tubular members are interconnected together using a plurality of a keyed tubular insert joints of the type described above. In the tubular frame structure 10 of FIG. 1, non-tubular frame components are also provided, such as side plates 80 having openings 82 through which a dough mixer drive shaft assembly can extend, a curved top cover plate 84 and corner stabilizing brackets 86. The side plates 80 include extension tabs on all sides that fit into slotted openings of the surrounding tubular frame members, and which are welded to the frame members at the perimeter of the slots. Likewise, the top cover plate includes slots into which upper extension tabs of the upright tubular members 12a-12d extend, with welds included. The frame feet 88a-88d may be connected to the upright tubular members using extension tabs on the lower ends of tubular members 12a-12d and openings sized to receive the extension tabs.

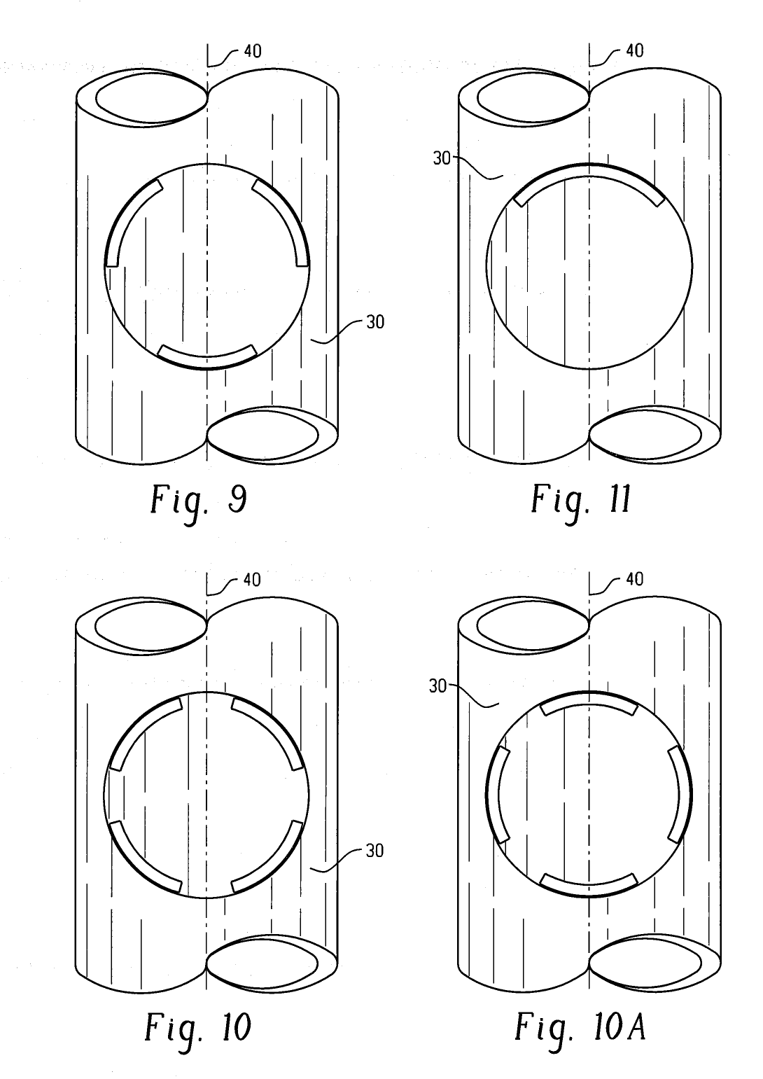

While a keyed insert joint having a primary tube receiving opening 34 and two sidewall extension tab receiving openings 44 and 46 is described above, it is recognized that the number of sidewall extension tabs and corresponding sidewall extension tab receiving openings could be only one or could be greater than two (3 or 4 or 1 as shown in the embodiments of FIGS. 9, 10 and 11). Moreover, as mentioned above, keyed tubular joints other than the insert type described above could be used.

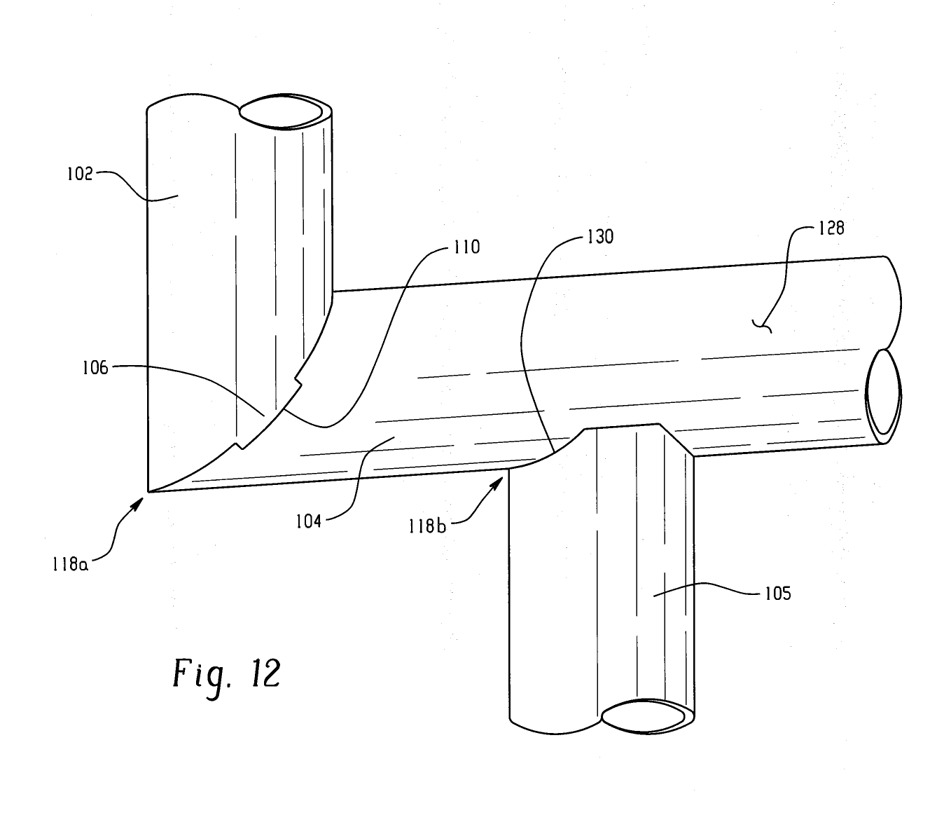

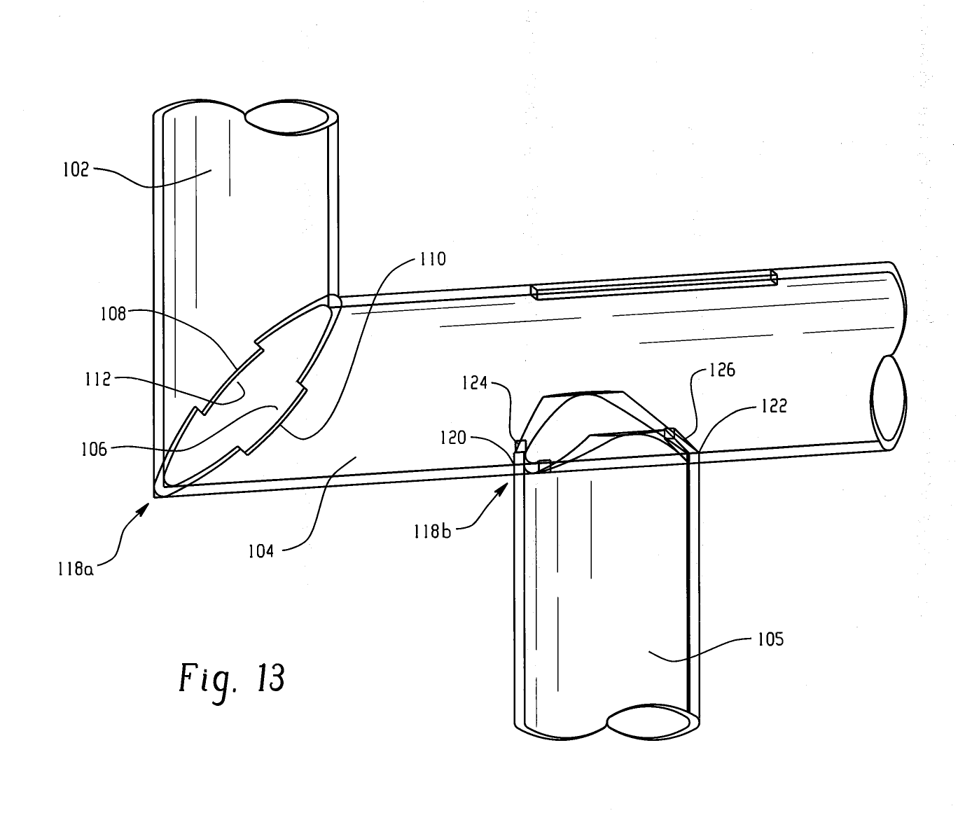

In this regard, reference is made to the miter-type keyed tubular joint 118a of FIGS. 12 and 13, which joins tubular members 102 and 104 of the same cross-sectional size. In this case, tubular member 102 includes sidewall extension tabs 106 and 108 and the end edge of the sidewall of tubular member 104 includes openings 110 and 112 in the form of recesses sized to receive the extension tabs 106 and 108. The tabs and end edge openings operate to assist in holding the tubular members 102 and 104 in proper position during welding along the interface of the two mitered end edges of the respective member sidewalls. Again, while the illustrated embodiment includes two extension tabs and openings, the number could vary (e.g., one tab and one corresponding opening, or more than two tabs and more than two corresponding openings).

An external flush-type keyed tubular joint 118b is also shown in FIGS. 12 and 13, which joins tubular members 104 and 105. In the illustrated embodiment, tubular members 104 and 105 have the same cross-sectional size, but it is recognized that member 105 could have a smaller cross-sectional size than member 104 in this type of joint. In this joint 118b, tubular member 104 includes two openings 120 and 122 that receive two corresponding sidewall extension tabs 124 and 126 of tubular member 105. The remainder of the end edge of the sidewall of tubular member 105 is shaped to seat flushly against an external surface 128 of the tubular member 104 when the end tabs 124 and 126 are inserted into the openings 120 and 122. The joint is welded along the entire periphery 130 of the interface between the two members. Again, while the illustrated embodiment includes two extension tabs and openings, the number could vary (e.g., one tab and one corresponding opening, or more than two tabs and more than two corresponding openings).

It is to be clearly understood that the above description is intended by way of illustration and example only, is not intended to be taken by way of limitation, and that other changes and modifications are possible. For example, while joints made up of tubular members having similar cross-sectional shape are primarily shown, similar joints between two tubular members of different cross-sectional shape could be formed as well. Moreover, while the illustrated joints having multiple engaged sidewall extension tabs and openings are generally shown with all tabs having the same size, all openings having the same size and with the tabs and openings in each case generally symmetrically positioned, it is recognized that (i) the tabs at the end of any give tubular member could be of different size, in which case the openings in a mated tubular member would preferably also be of different size to match a respective tab and (ii) the tabs and openings need not be arranged symmetrically. Further. while certain orientations of the sidewall openings are shown (e.g., such as the four sidewall tab extension receiving openings in FIG. 10), the orientations could vary (e.g., the four sidewall tab extension receiving openings could be oriented as shown in FIG. 14)

What is claimed is:

1. A method of constructing a metal tubular frame structure utilizing a first tubular member and a second tubular member, the method comprising:
utilizing at least one opening in the first tubular member and at least one end tab on the second tubular member that together produce a keyed tubular joint when the second tubular member engages the first tubular member with the tab inserted within the opening.

2. The method of claim 1 including:
welding the keyed tubular joint to secure the first tubular member to the second tubular member;
wherein the opening is located on an end edge of the first tubular member, the end tab is located on an end edge of the second tubular member, wherein a transverse cross-sectional size of the first tubular member is the same as a transverse cross-sectional size of the second tubular member, and the second tubular member engages the first tubular member in a miter style joint in which the tab and opening operate to assist in holding the first and second tubular members in proper position during the welding step.

3. The method of claim 2 wherein at least two openings are located on the end edge of the first tubular member and at least two corresponding end tabs are located on the end edge of the second tubular member.

4. The method of claim 1 including:
welding the keyed tubular joint to secure the first tubular member to the second tubular member;
wherein the opening is located through a sidewall of the first tubular member, the end tab is located on an end edge of the second tubular member, and the end edge of the second tubular member is shaped to seat flushly against an external surface of the first tubular member when the end tab is inserted into the opening.

5. The method of claim 4 wherein:
wherein a transverse cross-sectional size of the first tubular member is the same as a transverse cross-sectional size of the second tubular member;
at least two openings are located through the sidewall of the first tubular member and at least two corresponding end tabs are located on the end edge of the second tubular member.

6. The method of claim 1 wherein
a transverse cross-sectional size of the first tubular member is larger than a transverse cross-sectional size of the second tubular member; and
a set of openings are located through a sidewall of the first tubular member and interact with the second tubular member to produce a keyed tubular insert joint when the second tubular member is inserted into the first tubular member.

7. The method of claim 6, including:
the first tubular member including a first opening in the sidewall of the first tubular member, the first opening shaped and sized to substantially match an outer perimeter shape of a sidewall of the second tubular member;
the first tubular member including at least a second opening in the sidewall of the first tubular member and spaced from the first opening but aligned along a length of the first tubular member with the first opening;
the second tubular member including at least a first sidewall extension tab in a first end of the second tubular member, the first sidewall extension tab sized and shaped to substantially match the size and shape of the second opening;
inserting the first end of the second tubular member into the first opening of the first tubular member;
aligning the first sidewall extension tab of the second tubular member with the second opening of the first tubular member;
moving the first end of the second tubular member further into the first opening of the first tubular member so that the first sidewall extension tab moves into the second opening, such that rotation of the second tubular member relative to the first tubular member is substantially inhibited by interaction of the first sidewall extension tab and the second opening.

8. The method of claim 7, including the further steps of
welding the first sidewall extension tab of the second tubular member to the sidewall of the first tubular member; and
welding the sidewall of the second tubular member to the sidewall of the first tubular member along a perimeter of the first opening.

9. The method of claim 6, including the steps of:
the first tubular member including a first opening in a sidewall of the first tubular member, the first opening shaped and sized to substantially match an outer perimeter shape of a sidewall of the second tubular member;
the first tubular member including at least second and third openings in the sidewall of the first tubular member in respective positions that are spaced from the first opening, but that are aligned along a length of the first tubular member with the first opening;
the second tubular member including at least first and second sidewall extension tabs in a first end of the second tubular member, the first and second sidewall extension tabs sized and shaped to substantially match the size and shape of the second and third openings;
inserting the first end of the second tubular member into the first opening of the first tubular member;
aligning the first sidewall extension tab of the second tubular member with the second opening of the first tubular member, and aligning the second sidewall extension tab of the second tubular member with the third opening of the second tubular member;
moving the first end of the second tubular member further into the first opening of the first tubular member so that the first sidewall extension tab moves into the second opening and the second sidewall extension tab moves into the third opening, such that rotation of the second tubular member relative to the first tubular member is substantially inhibited by interaction of the first sidewall extension tab and the second opening and the second sidewall extension tab and the third opening.

10. The method of claim 9, including the further steps of
welding the first sidewall extension tab of the second tubular member to the sidewall of the first tubular member;
welding the second sidewall extension tab of the second tubular member to the sidewall of the first tubular member; and
welding the sidewall of the second tubular member to the sidewall of the first tubular member along a perimeter of the first opening.

11. The method of claim 10 wherein the first sidewall extension tab and the second sidewall extension tab are sized to move into, but not entirely through, the second opening and the third opening respectively.

12. The method of claim 11 wherein the welding steps completely fill an exterior side of both the second opening and the third opening with weld material.

13. The method of claim 10 wherein a fillet weld is produced between the sidewall of the second tubular member and the sidewall of the first tubular member along the perimeter of the first opening.

14. The method of claim 10 wherein the first and second sidewall extension tabs are formed such that an end slot formed in the sidewall of the second tubular member in a region between the first and second sidewall extension tabs defines a sidewall end edge that is configured to match a shape of an internal surface of the sidewall of the first tubular member in a region between the second and third openings.

15. The method of claim 14 wherein in the moving step the sidewall end edge is moved into contact with the internal surface of the sidewall of the first tubular member.

16. The method of claim 7 wherein the first tubular member further includes a fourth opening, a third sidewall extension tab is formed in the sidewall of the second tubular member, the third sidewall extension tab is aligned with and moved into the fourth opening.

17. The method of claim 7 wherein each of the first and second sidewall extension tabs includes an end edge that is contoured in a lengthwise direction of the second tubular member to match varying position of the sidewall of the first tubular member in each of the second and third openings respectively.

18. A metal tubular frame structure, comprising:
a first tubular member;
a second tubular member;
the first tubular member and second tubular member joined together, with at least one opening of the first tubular member and at least one end tab of the second tubular member engaged to define a keyed tubular joint.

19. The metal tubular frame structure of claim 18, wherein:
a transverse cross-sectional size of the first tubular member is larger than a transverse cross-sectional size of the second tubular member
the first tubular member having a first sidewall opening shaped and sized to substantially match an outer perimeter shape of a sidewall of the second tubular member, and a second sidewall opening and a third sidewall opening in respective positions that are spaced from the first opening but aligned with the first opening along a length of the first tubular member;
the second tubular member having a first end with first and second sidewall extension tabs formed therein, the first and second sidewall extension tabs sized and shaped to substantially match the size and shape of the second and third openings respectively;
wherein the first end of the second tubular member is located within the first opening of the first tubular member, with the first sidewall extension tab located within the second opening and the second sidewall extension tab located within the third opening.

20. The metal tubular frame structure of claim 19, wherein:
the first sidewall extension tab is welded to the sidewall of the first tubular member to cover an exterior side of the second opening with weld material;
the second sidewall extension tab is welded to the sidewall of the first tubular member to cover an exterior side of the third opening with weld material; and
the sidewall of the second tubular member is welded to the sidewall of the first tubular member to form a fillet weld along a perimeter of the first opening.

21. The metal tubular frame structure of claim 20 wherein the first and second sidewall extension tabs are formed such that an end slot formed in the sidewall of the second tubular member in a region between the first and second sidewall extension tabs defines a sidewall end edge that matches a shape of an internal surface of the sidewall of the first tubular member in a region between the second and third openings, and the sidewall end edge is in abutting contact with the internal surface of the sidewall of the first tubular member.

22. The metal tubular structure of claim 21 wherein each of the first and second sidewall extension tabs includes an end edge that is contoured in a lengthwise direction of the second tubular member to match varying position of the sidewall of the first tubular member in each of the second and third openings respectively.

23. The metal tubular structure of claim 18 wherein:
the opening is located on an end edge of the first tubular member, the end tab is located on an end edge of the second tubular member, wherein a transverse cross-sectional size of the first tubular member is the same as a transverse cross-sectional size of the second tubular member, and the second tubular member engages the first tubular member in a miter style joint in which the tab and opening operate to assist in holding the first and second tubular members in proper position

24. The metal tubular structure of claim 18 wherein:
a transverse cross-sectional size of the first tubular member is the same as a transverse cross-sectional size of the second tubular member;
the opening is located through a sidewall of the first tubular member, the end tab is located on an end edge of the second tubular member, and the end edge of the second tubular member is shaped to seat flushly against an external surface of the first tubular member when the end tab is inserted into the opening

25. A dough handling apparatus including the metal tubular frame structure of claim 18, wherein the dough handling apparatus is one of a horizontal dough mixer, a rotary dough feeder, a spiral dough feeder or a dough divider.
